(19) United States
(12) Patent Application Publication
(10) Pub. No.: US 2009/0282327 A1
(43) Pub. Date: Nov. 12, 2009

(54) METHOD AND SYSTEM FOR EFFICIENT WEB PAGE RENDERING

(75) Inventors: Rick A. Hamilton, II, Charlottesville, VA (US); Brian M. O'Connell, Cary, NC (US); Clifford A. Pickover, Yorktown Heights, NY (US); Keith R. Walker, Austin, TX (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/118,829

(22) Filed: May 12, 2008

(51) Int. Cl. G06F 17/00

(52) U.S. Cl. 715/231

(57) ABSTRACT

Web page annotation instructions comprise efficient and alternative instructions for rendering object data to a web page viewer, wherein the efficient instruction renders the object data to a web page viewer with less resource expenditure. An efficient rendering choice may be visually indicated and selectable by a viewer. Annotation instructions may indicate a relevance value of object data determinative of displaying object data. Efficient instructions may instruct a server device to not allocate new central processing units to serve requests to view the web page. Annotations may comprise first and second hypertext resource reference for a data object, wherein using the first results in rendering object data with a smaller resource expenditure than using the second, for example through divergent server efficiencies or divergent referenced object resolution properties. A resource contemplates energy and resource expenditures; generated waste, pollution and heat quantities and environmental impact.

### FIELD OF THE INVENTION

The present invention generally describes a method, system and device for reducing resource requirements in rendering internet web pages, and more particularly as a function of web content annotations.

### BACKGROUND OF THE INVENTION

Green computing has been defined as the study and practice of using computing resources efficiently. Typically, technological systems or computing products that incorporate green computing principles take into account economic viability, social responsibility and environmental impact. In particular, green computing includes efforts to obtain maximized energy and resource efficiency from the computer resources being used, and in one aspect to reduce associated waste and negative environmental impacts. Green computing may also be described as the science behind efficient computing and performing tasks on a smaller power budget.

All computer usage consumes energy and, depending on the energy source, such usage may also increase greenhouse gas emissions. Both the United States Government and the information technology industry have recognized the importance of efficient computing in order to reduce greenhouse gas emissions resulting from energy or power consumption. Large government and commercial initiatives are underway to identify environmentally conscious information technology programs and the most efficient computers.

Generating and viewing internet web pages generally involves formatting and presenting a variety of content data. A web page may include text items, graphic images, three-dimensional renderings, and links and embedded objects comprising audio and video content which may run within a web page through one or more applet applications and “plug-ins,” each of which may reside in one more locations, requiring the expenditure of energy and resources in retrieving, loading, running and/or rendering the various web page items to a viewer. For example, each image within a web page document generally results in a distinct request to a serving infrastructure to retrieve an associated image object, and every request requires power for a server to return the image, a network infrastructure to transmit the request and the image object, as well as computational cycles to parse image object content and display the resulting image. Thus retrieving and rendering graphic files and multi-media content requires more expenditure of energy and resources than simple text content rendering, resources needlessly squandered if the graphic or multi-media content is not of use to or otherwise required or desired by a web page viewer.

Thus, there is a need for improved methods and systems that address the above problems, as well as others.

### SUMMARY OF THE INVENTION

Methods, systems and devices are provided here for selective alternative rendering of a web page. Methods comprise creating web pages comprising object data and annotation instructions for rendering the object data on the web page to a viewer, the annotation instructions comprising an efficient instruction for rendering the object data to the web page viewer and an alternative instruction for rendering the object data to the web page viewer; selecting the efficient instruction or the alternative instruction; and rendering the object data to the web page viewer pursuant to the selected efficient instruction or the selected alternative instruction; wherein rendering the object data to the web page viewer pursuant to the selected efficient instruction requires a rendering resource expenditure less than a rendering resource expenditure required to render the object data to the web page viewer pursuant to the alternative instruction.

Some methods further comprise parsing annotation instructions, wherein selecting the efficient instruction or the alternative instruction is a function of the parsing and a system configuration. Methods also further comprise visually indicating to the web page viewer an efficient rendering choice associated with the object data, wherein selecting the efficient instruction comprises the viewer indicating a preference for the efficient rendering choice relative to the alternative instruction. Other methods comprise annotation instructions indicating a relevance value of the object data with respect to a content of the web page; comparing the relevance value to a threshold value; and selecting the efficient instruction or the alternative instruction as a function of the compared relevance value meeting or failing to meet the threshold value. Methods also comprise parsing annotation instructions or object data to determine a relevance value.

Some methods comprise rendering object data pursuant to the selected alternative instruction by rendering an included optional object data item, and rendering the object data pursuant to the selected efficient instruction by omitting rendering the included optional object data item. Other methods comprise rendering object data pursuant to a selected efficient instruction by instructing a load-balancing server device to not allocate a new central processing unit to serve a request by the viewer to view the web page.

Methods also comprise an efficient instruction instructing a web page hosting provider to render object data by using a first hypertext resource reference, and an alternative instruction instructing to render the object data by using a second hypertext resource reference, wherein using the first hypertext resource reference to render the object to the viewer requires a smaller resource expenditure than using the second hypertext resource reference to render the object to the viewer. In one method, the first hypertext resource reference is a reference to a first object located on a first server, and the second hypertext resource reference is a reference to a second object located on a second server, wherein rendering the object data comprises obtaining the first object from the first server pursuant to the selected efficient instruction or obtaining the second object from the second server pursuant to the selected alternative instruction, an obtaining of the first object from the first server requiring the resource expenditure smaller than the resource expenditure required for obtaining the second object from the second server. In another method, the first hypertext resource reference is a reference to a low-resolution object and the second hypertext resource reference is a reference to an alternative resolution object, the alternative resolution object having a resolution value higher than a resolution value of the low-resolution object, wherein rendering the object data comprises retrieving and rendering the low-resolution object pursuant to the selected efficient instruction or retrieving and rendering the alternative resolution object pursuant to the selected alternative instruction, the retrieving and rendering of the low-resolution object requiring the resource expenditure smaller than the resource expenditure required to retrieve and render the alternative resolution object.

In some methods, the rendering resource expenditure is selected from the group consisting of energy expenditure, resources expenditure, a generated waste quantity, a generated pollution emission quantity, a generated heat quantity and an amount of environmental impact.

In another aspect, methods are provided for deploying an application providing a computer infrastructure being operable to perform one or more of the method and/or process elements for selective alternative rendering of a web page described herein, for example, by a service provider who offers to implement, deploy, and/or perform functions for others. Still further, an article of manufacture comprising a computer usable medium having the computer readable program embodied in said medium may be provided. Such program codes comprise instructions which, when executed on a computer system, cause a computer system to perform one or more of the methods and/or process elements for selective alternative rendering of a web page. Moreover, systems, articles and programmable devices configured for performing one or more of the method and/or process elements of the present invention for selective alternative rendering of a web page, for example as described herein, are also disclosed.

### BRIEF DESCRIPTION OF THE DRAWINGS

These and other features of the methods, systems and devices for carbon offsetting will be more readily understood from the following detailed description of the various aspects of the embodiments taken in conjunction with the accompanying drawings in which:

FIG. 1 is a flow chart illustrating a method and system for selective efficient rendering of an internet web page according to the present application.

FIG. 2 is a system or device configured to provide selective efficient rendering of an internet web page according to the present application.

FIG. 3 is a block diagram illustrating a computerized device implementation of a method and system for selective efficient rendering of an internet web page according to the present application.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

The present application discloses systems, methods, devices and program products that enable internet web page viewers, content creators and providers to selectively reduce an overall energy, resource or environmental footprint required to view and browse web pages and web sites. More particularly, a web page may comprise annotations, which may be defined or understood in a computer or programming context as instructional metadata linked to one or more data or instruction objects within the same document or web page. Generally, annotations describe something about the data or instructions without altering the data or instructions.

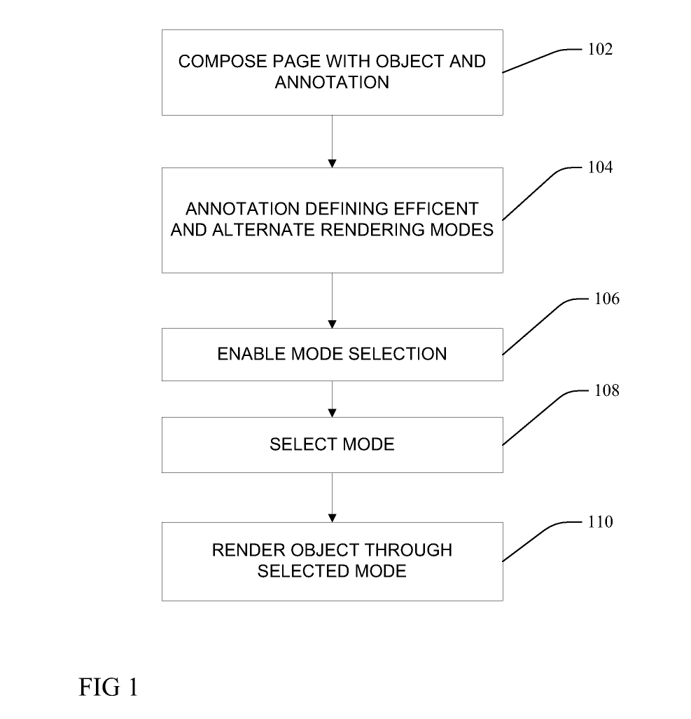

Referring now to FIG. 1, a method, system or process for selective efficient rendering of an internet web page according to the present application is illustrated. At 102 a web page or document is created or composed comprising at least one item or data object and annotation instructions associated with the object, the annotations provided for rendering the object data on the web page to a viewer. At 104 the annotation instructions further provide at least one efficient instruction for rendering the object data and at least one alternative instruction, wherein the alternative instruction may be for a standard, high-performance or other rendering of the object data which requires more energy or more resources, or results in processing demands that result in a higher waste or environmental impact cost on rendering the object data, compared to the efficient instruction.

At 106 the selection of the efficient instruction or the alternative instruction is enabled, for example by a web page content creator or through an analysis of the annotations and a system configuration by a web pager provider or viewing entity. At 108 one of the modes is selected, for example manually by a viewer, automatically as a function of a preference or configuration setting, or through a web page provider or browser determination. At 110 the object data is rendered to a web page viewer pursuant to the selected efficient instruction or the selected alternative instruction.

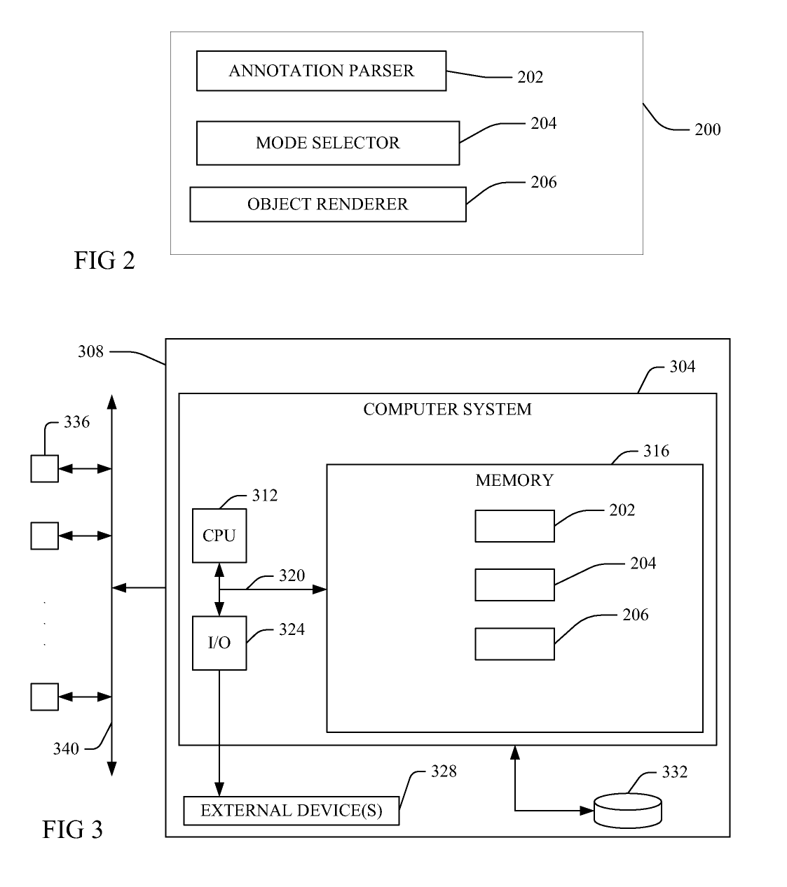

Determining or recognizing, selecting, implementing and rendering the object data pursuant to the efficient and alternative annotation instructions may occur through a plurality of apparatuses or software programs. Some embodiments are described more fully below and other examples will be apparent to one skilled in the art, and numerous modifications and substitutions are possible without deviating from the claims of the invention. In one aspect, FIG. 2 illustrates an embodiment of a system or device 200 configured to provide selective efficient rendering of an internet web page according to the present application comprising: an annotation parser 202, a mode selector 204, and an object renderer 206. The annotation parser 202 comprises logic components configured to parse or otherwise analyze web page object annotations in order to recognize efficient and alternative instructions for rendering the object data according to the present application. The mode selector 204 comprises logic components configured to implement a selected annotation instruction or mode of instruction implementation, and the object renderer 206 causes a web page provider to render the web page content object data in a mode or configuration pursuant to the selected mode or annotation instruction.

In one aspect of a system, method or process of FIG. 1 and FIG. 2, and as otherwise described herein, a web browser may enable a user to select a green (e.g., energy-conserving) mode in which content creators' annotations for energy efficiency are observed. Content may be annotated with efficient-instruction metadata describing operations to display the web page that are more energy efficient than normal methods. Additionally, metadata may be parsed, for example by web hosting providers or web viewer browser applications, to determine and provide methods to efficiently serve the web pages.

In some examples, a web page viewer or provider may achieve desired efficiencies by specifying an acceptable delay or loss of quality for web requests in order to reduce power consumption. An interface for selecting efficient or alternative modes, or for specifying delay/quality settings, etc., may reside on a browser graphical user interface (GUI), for example, in the form of a switch, dial, or slider. Furthermore, a web hosting provider may parse the annotations within the web content prior to delivering that content to a web browser and perform actions to serve the content in the most energy efficient manner as dictated by the web page annotations. In one aspect, a web page viewer, provider or other user need not actively specify a green mode or efficient instruction implementation, but a selection may instead be made by a user's company or employer or other supervisory entity, or selected automatically, for example, by a software agent that determines that a green mode should be selected.

Methods and processes according to the present application may be practiced or achieved through browser-based annotation processing. More particularly, web page creators embed hypertext references (HREF's) annotation links within web pages, which enable a viewer of the page to browse another web site, move to a different location or within the same site or page, view an image from a linked image file, etc. In some examples, an HREF includes a destination object as the value of the HREF: for example, an HREF of “href=image.gif” will take a page viewer to a picture called “image.gif.”

According to the present application, “green” HREF's may be incorporated into web pages by content creators. In some embodiments, alternative “green” and “non-green” HREF's comprising hypertext markup language (HTML) or extensive mark-up language (XML) links are provided for a web page content item, wherein a green HTML or XML-linked file may be selected to handle a referenced material request. In one example, two separate HREF's are provided for a reference to a “Chapter 2” content item, a green reference “<A href=“chapter2.html” ghref=http://www.green.org/chapter2.html >chapter two</A>” and an alternative non-green reference “<A href=“chapter2.html” >chapter two</A>,” wherein the green HREF “ghref” HTML file is used to provide the “Chapter 2” content to a web page viewer when selected, otherwise the other conventional “href” file is used. In another example, a combination HREF is provided for the same item: “<A href=“chapter2.html” ghref=“chapter2g.html” >chapter two</A>”, wherein a selection is made between the two HTML file links contained within a single HREF definition.

In some embodiments, selecting a green HREF results in an image request being handled by a green hosting location that provides power savings or other efficiencies relative to another hosting location referenced by a non-green HREF. In some examples, a green site may have a sub-optimal performance compared with a non-green hosting site, and thus implementing a green mode or selecting the green HREF or associated annotation link also involves a selection of relative performance.

In some embodiments, web page viewers may manually select green or non-green HREF's. HREF's may comprise a visual annotation for presentation to a page viewer in order to indicate green-viewing option information, for example informing a viewer which sites linked from a given page are green. Thus, an image may be provided near a green link to indicate that the link is hosted by a green server, perhaps utilizing an image pre-defined or readily associated with green computing such as a small picture of the earth, a green orb, or an Energy Star logo. Other appropriate icons and images will be apparent to one skilled in the art. Energy-conscious viewers may use such configurations to intentionally choose to patronize sites that have reduced energy footprints rather than conventional or other relatively non-efficient sites, which may be advantageous to green providers when viewers have a plurality of sites to select from (for example, when presented with a list of choices returned by a browser search engine).

Providing notice to viewers of the availability of resource savings according to the present application provides advantages in encouraging users to select low-performance sites, enabling the viewer to make a conscious choice to save energy and resources, and sometimes to purposefully achieve better energy efficiency at the expense of page viewing performance. This may be particularly successful when, in the user's judgment, high performance is not needed for a given viewing task and thus no great cost or sacrifice is perceived by the selecting user, or at least not greater than a perceived benefit accrued by user electing to save energy or resources. In another aspect, encouraging feedback may also be provided to the user, such as an auditory signal or visual display of cumulative resource savings achieved. Historic savings associated with the viewer or client machine or application may thus be displayed to the viewer, or a web browser may display a counter dynamically updating real-time resources savings being presently achieved, for example indicating a number of estimated kilowatts saved by the viewer's green browsing choices. Thus, a viewer may receive a visual or auditory reward, as well as be informed of a specific positive impact made by his or her green viewing choices.

In another advantage, methods and systems according to the present application may achieve expansion of the adoption of green computing methods by content providers, for example by encouraging content providers to lower their energy footprint in order to qualify for association with a green computing visual indicator in search results. Such markings may attract more energy-conscious viewer visits to their sites, as well as a corresponding associated increase in advertising or other web traffic-driven revenue, particularly where revenues from increasing web traffic is perceived by the provider to exceed the cost or burden of reducing their energy footprint. Web page owners or designers may also derive value by specifying preferences or defaults for green annotation usage, in one example by being rewarded with web hosting fee decreases or credits. In some embodiments a web page hosting company may scan a web page for green annotations and determine rewards accordingly, for example by using a software agent.

An image presented within a web page document may result in a distinct request to a serving infrastructure to retrieve an associated image object, and every such request requires power for a server to return the image and for a network infrastructure to transmit the request and the image object, as well as for computational cycles to parse the image object content and display the resulting image. Thus, some embodiments according to the present application may incorporate, determine or apply image annotation data tags that indicate an image importance or a relevance of the image to the web page document, in one aspect to further effect or enable image elision methods and systems to improve web page efficiency as a function of the relevance tag data.

More particularly, energy and resource savings may be realized through selective reductions in image retrievals. Thus, in an example where tags are applied to images indicating their importance in understanding the context of the document, annotations on a web page describing physics equations may include “required” or “high importance” tags for images of equations, and page annotations for a www.wikipedia.org entry item on a particular company may comprise “not required” or “low-importance” tags for an image of the company's corporate logo, as the logo will have a low significance with respect to understanding the document. Relevance may be indicated in a variety of ways, for example including binary flag tags or numerical rankings. A browser operating in a green mode according to the present application may thus omit images with “not required” tags; or optionally let a user manually request images potentially omitted, for example through clicking on an icon or object taking the place of the omitted image. In some embodiments, web page content providers include an image relevance tag directly within an image annotation: for example, in “<img src=“boat.gif” content_relevance=“2”> the “2” is a numerical relevance ranking.

In another aspect, web page annotations may be used to specify server selection or processing methods to realize efficiencies in rendering a web page. In one example, a designer of a web page may use a green annotation tag to specify alternate less resource-intensive images for transmission, or a greener method to serve one or more images on the web page.

In some embodiments, incentives are provided for adopting green methods. For example, if an owner of a web-page (or other responsible party) uses specified green tags to allow web page rendering (in some examples also further meeting an appropriate greenness requirement), then a web page creator or owner/responsible party may be given a reward incentive (such as a reduced price for hosting a page, etc.). In some embodiments, a web page hosting provider parses a web page for green annotations upon publication of a web page to the hosting provider, and if power-saving annotations are discovered, the web hosting provider may use the information provided in the annotations to conserve energy while serving the web page.

Resource efficiencies may be achieved through serving efficient images containing less bytes or by serving a web page from green servers or though efficient system instructions and configurations, enabling a web-page designer or owner to specify a default, preferred, or acceptable level of greenness. In one example, a “<green newcpu=no degrade_images=yes >” annotation may be inserted into a comment with a green container tag in a web page, the green tag notifying the server that the page has a green annotation. So notified, the first “newcpu=no” annotation parsed by the server instructs the server to not allocate a new CPU to serve a request for this page, which reduces resource usage in a load-balancing environment wherein web requests are spread across a plurality of computers by preventing the engagement of another server. The second “degrade_images=yes” annotation instructs a web server that it may provide images that consume fewer resources instead of high-quality images; this may result in reducing image rendering to a specified low-resolution setting regardless of the definition of the original image, or in one aspect degraded images may be stored alongside high-quality images thereby enabling a server to select an appropriate proper image through a simple selection process.

Application of green annotations may depend upon observations of computer infrastructural parameters and constraints. For example, one or more policies may dictate that “green” policies described by green annotations are triggered only at a point that new processors (or grid nodes) need to be turned on to maintain such service delivery, wherein prior to this point full high-performance service delivery methodology is followed. By delaying or preventing the implementation of new power-consuming physical resources overall processor loading may be reduced and direct resource and energy savings achieved, yet high-performance web page rendering may also be practiced until an opportunity for energy or resource savings is presented, and thus the over-all efficiency in delivering the high-performance services is also improved.

In another aspect, users (or their employers, organizations or other responsible or supervisory entities) may establish policy tables that specify when to use green web features as a function of a plurality of parameters. Policy examples include specifying (or defaulting to) green settings during certain times of day in anticipation of likely high or peak energy use or costs thereof; during time periods when network traffic is above a particular threshold; or during time periods when energy demands are high and/or expensive. Other policies may also be implemented, with each weighted as required or desired, as will be appreciated by one skilled in the art. Web page hosting services may also use such tables to make their own determinations.

### II. Computerized Implementation

Referring now to FIG. 3, an exemplary computerized implementation includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage system 332. In general, the processing unit 312 executes computer program code, such as the code to implement various components of the process and system for implementing power savings on client-side computational devices as illustrated in FIGS. 1 and 2 and described above, including the annotation parser 202, the mode selector 204, and the object renderer 206 components discussed above, which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboard, pointing device, display, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 3 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement power saving methods on client-side computational devices. To this extent, the computer-readable/useable medium includes program code that implements each of the various process steps of the invention.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation could be deployed, managed, serviced, etc. by a service provider who offers to implement, deploy, and/or perform the functions of the present invention for others, for example by licensing methods and browser or application server technology according to the present invention to an internet service providers (ISP) or cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the invention for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the implementation of power savings methods on client-side computational devices. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for selective alternative rendering of a web page, comprising:
creating a web page comprising object data and annotation instructions for rendering the object data on the web page to a viewer, the annotation instructions comprising an efficient instruction for rendering the object data to the web page viewer and an alternative instruction for rendering the object data to the web page viewer,
selecting the efficient instruction or the alternative instruction;
rendering the object data to the web page viewer pursuant to the selected efficient instruction or the selected alternative instruction; and
wherein rendering the object data to the web page viewer pursuant to the selected efficient instruction requires a rendering resource expenditure less than a rendering resource expenditure required to render the object data to the web page viewer pursuant to the alternative instruction.

2. The method of claim 1, further comprising parsing the annotation instructions, and wherein the selecting the efficient instruction or the alternative instruction is a function of the parsing and a system configuration.

3. The method of claim 2 further comprising visually indicating to the web page viewer an efficient rendering choice associated with the object data, and wherein selecting the efficient instruction comprises the viewer indicating a preference for the efficient rendering choice relative to the alternative instruction.

4. The method of claim 3, further comprising:
the annotation instructions indicating a relevance value of the object data with respect to a content of the web page;
comparing the relevance value to a threshold value; and
selecting the efficient instruction or the alternative instruction as a function of the compared relevance value meeting or failing to meet the threshold value.

5. The method of claim 4, further comprising parsing the annotation instructions or the object data to determine the relevance value.

6. The method of claim 3 wherein rendering the object data to the web page viewer pursuant to the selected alternative instruction comprises rendering an included optional object data item; and
rendering the object data to the web page viewer pursuant to the selected efficient instruction comprises omitting rendering the included optional object data item.

7. The method of claim 3 wherein rendering the object data to the web page viewer pursuant to the selected efficient instruction comprises instructing a load-balancing server device to not allocate a new central processing unit to serve a request by the viewer to view the web page.

8. The method of claim 3, further comprising:
the efficient instruction instructing a web page hosting provider to render the object data by using a first hypertext resource reference; and
the alternative instruction instructing the web page hosting provider to render the object data by using a second hypertext resource reference;
wherein using the first hypertext resource reference to render the object to the viewer requires a smaller resource expenditure than using the second hypertext resource reference to render the object to the viewer.

9. The method of claim 8, wherein the first hypertext resource reference is a reference to a first object located on a first server, and the second hypertext resource reference is a reference to a second object located on a second server; and
wherein the rendering the object data to the web page viewer comprises obtaining the first object from the first server pursuant to the selected efficient instruction or obtaining the second object from the second server pursuant to the selected alternative instruction, an obtaining of the first object from the first server requiring the resource expenditure smaller than the resource expenditure required for obtaining the second object from the second server.

10. The method of claim 8, wherein the first hypertext resource reference is a reference to a low-resolution object and the second hypertext resource reference is a reference to an alternative resolution object, the alternative resolution object having a resolution value higher than a resolution value of the low-resolution object; and
wherein rendering the object data to the web page viewer comprises retrieving and rendering the low-resolution object pursuant to the selected efficient instruction or retrieving and rendering the alternative resolution object pursuant to the selected alternative instruction, the retrieving and rendering of the low-resolution object requiring the resource expenditure smaller than the resource expenditure required to retrieve and render the alternative resolution object.

11. The method of claim 3 wherein the rendering resource expenditure is selected from the group consisting of an energy expenditure, a resources expenditure, a generated waste quantity, a generated pollution emission quantity, a generated heat quantity and an amount of environmental impact.

12. A method for deploying an application enabling selective alternative rendering of a web page, comprising:
providing a computational device infrastructure configured to:
parse web page annotation instructions associated with web page object data, the annotation instructions comprising an efficient instruction for rendering the object data to a web page viewer and an alternative instruction for rendering the object data to the web page viewer;
select the efficient instruction or the alternative instruction as a function of a viewer resource usage preference input; and
render the object data to the web page viewer pursuant to the selected efficient instruction or the selected alternative instruction;
wherein rendering the object data to the web page viewer pursuant to the selected efficient instruction requires a rendering resource expenditure less than a rendering resource expenditure required to render the object data to the web page viewer pursuant to the alternative instruction.

13. The method for deploying an application of claim 12, wherein the computer infrastructure is further configured to cause a display means to visually indicate to the web page viewer an efficient rendering choice associated with the object data, and select the efficient instruction in response to the viewer indicating a preference for the efficient rendering choice relative to the alternative instruction through the viewer resource usage preference input.

14. The method for deploying an application of claim 13, the annotation instructions further indicating a relevance value of the object data with respect to a content of the web page, and wherein the computer infrastructure is further configured to parse the relevance value and selecting the efficient instruction or the alternative instruction as a function of the relevance value meeting or failing to meet a threshold value.

15. A method for enabling selective alternative rendering of a web page, comprising:
producing computer executable program code;
storing the code on a computer readable medium;
providing the program code to be deployed and executed on a computer system, the program code causing the computer system to:
parse web page annotation instructions associated with web page object data, the annotation instructions comprising an efficient instruction for rendering the object data to a web page viewer and an alternative instruction for rendering the object data to the web page viewer;
select the efficient instruction or the alternative instruction as a function of a viewer resource usage preference input; and
render the object data to the web page viewer pursuant to the selected efficient instruction or the selected alternative instruction;
wherein rendering the object data to the web page viewer pursuant to the selected efficient instruction requires a rendering resource expenditure less than a rendering resource expenditure required to render the object data to the web page viewer pursuant to the alternative instruction.

16. The method of claim 15, the program code comprising instructions which, when executed on the computer system, causes the computer system to render the object data to the web page viewer pursuant to parsing the selected alternative instruction by rendering an included optional object data item, or render the object data to the web page viewer pursuant to parsing the selected efficient instruction by omitting rendering the optional object data item.

17. The method of claim 16, the program code comprising instructions which, when executed on the computer system, causes the computer system to instruct a load-balancing server device to not allocate a new central processing unit to serve a request by the viewer to view the web page pursuant to parsing the selected efficient instruction.

18. A programmable device comprising:
a processing means;
a memory in communication with the processing means comprising an instruction parser logic component; and
a network interface in communication with the processing means and the memory;
wherein the processing means is configured to:
parse web page annotation instructions associated with web page object data, the annotation instructions comprising an efficient instruction for rendering the object data to a web page viewer and an alternative instruction for rendering the object data to the web page viewer;
select the efficient instruction or the alternative instruction as a function of a viewer resource usage preference input; and
render the object data to the web page viewer pursuant to the selected efficient instruction or the selected alternative instruction;
wherein rendering the object data to the web page viewer pursuant to the selected efficient instruction requires a rendering resource expenditure less than a rendering resource expenditure required to render the object data to the web page viewer pursuant to the alternative instruction.

19. The programmable device of claim 18, further comprising a display means in communication with the processing means, wherein the processing means is configured to visually indicate to the web page viewer an efficient rendering choice associated with the object data, and to select the efficient instruction in response to a viewer input indicating a preference for the efficient rendering choice relative to the alternative instruction.

20. The programmable device of claim 19 wherein the processing means is configured to instruct a load-balancing server device in communication with the processing means to not allocate a new central processing unit to serve a request by the viewer to view the web page pursuant to the selected parsed efficient instruction.
